(19) United States
(12) Patent Application Publication
(10) Pub. No.: US 2016/0011607 A1
(43) Pub. Date: Jan. 14, 2016

(54) ADAPTIVE COOLING OF COMPUTING DEVICES

(71) Applicant: Microsoft Technology Licensing, LLC, Redmond, WA (US)

(72) Inventors: Sean JAMES, Olympia, WA (US); Jie LIU, Medina, WA (US); Brian JANOUS, Issaquah, WA (US); Gregory Joseph MCKNIGHT, Bellevue, WA (US); Ricardo BIANCHINI, Bellevue, WA (US)

(73) Assignee: Microsoft Technology Licensing, LLC, Redmond, WA (US)

(21) Appl. No.: 14/675,300

(22) Filed: Mar. 31, 2015

Related U.S. Application Data
(60) Provisional application No. 62/023,788, filed on Jul. 11, 2014.

(51) Int. Cl. G05D 23/19; G05B 15/02

(52) U.S. Cl. CPC G05D 23/19; G05B 15/02

(57) ABSTRACT

This document relates to thermal management of computing devices. One example determines a cooling state associated with a computing device that has hardware resources including a processor and another hardware resource. The example also determines hardware utilization states of the computing device, including a processor utilization state and another hardware utilization state associated with the another hardware resource. The example also estimates a thermal impact on the computing device of operating in the cooling state and the hardware utilization states.

### PRIORITY

This application is a utility application that claims priority from provisional application 62/023,788 filed Jul. 11, 2014, which is incorporated by reference in its entirety.

### BACKGROUND

Large server installations such as data centers, server farms, etc., use vast amounts of electrical power to run servers and other equipment. This, in turn, causes the equipment to generate substantial amounts of heat. Accordingly, server installations often use various cooling mechanisms to control server temperatures.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to thermal management of computing devices. One example is a system that includes a hardware processing unit and a hardware storage device storing instructions. When the instructions are executed by the hardware processing unit, the instructions can cause the hardware processing unit to measure cooling states associated with a computing device at various times. The computing device can have hardware resources including a processor, a memory device, and a storage device. The instructions can also cause the hardware processing unit to determine hardware utilization states of the computing devices at the various times, the hardware utilization states including a processor utilization state associated with the processor, a memory utilization state associated with the memory device, and a storage utilization state associated with the storage device. The instructions can also cause the hardware processing unit to measure thermal impacts on the computing device of operating in the cooling states and hardware utilization states, and model the thermal impacts as a function of the cooling states and the hardware utilization states.

Another example is a system that includes a hardware processing unit and a hardware storage device storing instructions. When the instructions are executed by the hardware processing unit, the instructions can cause the hardware processing unit to determine a cooling state associated with a computing device. The computing device can have hardware resources including a processor and another hardware resource. The instructions can also cause the hardware processing unit to determine hardware utilization states of the computing device, including a processor utilization state and another hardware utilization state associated with the another hardware resource. The instructions can also cause the hardware processing unit to estimate a thermal impact on the computing device of operating in the cooling state and the hardware utilization states.

Another example includes a method or technique that can be performed by a computing device. The example includes determining a cooling state associated with a computing device having hardware resources including a processor and at least one of a memory device, a storage device, or a network device. The example also includes identifying a program configuration for the computing device. The program configuration includes a first executable program running on the computing device concurrently with a second executable program. The example also includes determining hardware utilization characteristics of the program configuration. The hardware utilization characteristics include a processor utilization characteristic and a data transfer characteristic of the program configuration. The data transfer characteristic can reflect data transfers by the memory device, the storage device, or the network device. The example also includes estimating a thermal impact of operating the program configuration on the computing device when the computing device is in the cooling state.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example computing device, consistent with some implementations of the present concepts.

FIG. 2 illustrates an example housing for multiple computing devices, consistent with some implementations of the present concepts.

FIG. 3 illustrates an example server installation configurations, consistent with some implementations of the present concepts.

FIG. 4 illustrates an example environment, consistent with some implementations of the present concepts.

FIGS. 5, 7, and 8 illustrate example methods or techniques, consistent with some implementations of the present concepts.

FIGS. 6, 9, and 10 illustrate example data structures, consistent with some implementations of the present concepts.

### DETAILED DESCRIPTION

### Overview

Cooling mechanisms for computing devices are often used in a reactive manner, e.g., waiting until temperatures reach a specified before activating a given cooling resource. Moreover, certain workload configurations can tend to generate more heat than other workloads, and it is not always apparent which workload configurations will generate the most heat. As a consequence, it can be difficult to take preemptive measures to avoid overheating a computing device or associated equipment.

Furthermore, using cooling resources in a reactive manner can be quite inefficient from an energy consumption standpoint. For example, in some cases, energy consumption can go up as a cubic function of fan speed. When using static temperature thresholds for turning on fans, the fans often need to run at relatively high speeds to accommodate bursts of thermally intense workloads. Thus, it can be beneficial to detect thermally intense workloads and use adaptive thermal management techniques to turn on fans earlier at relatively slower speeds when thermally-intense workloads are detected. This can have the effect of smoothing fan speeds over time rather than having bursts of high fan speeds and accompanying high energy usage. This is true both for individual computing device fans as well as fans that cool multiple computing devices, e.g., in a building such as a server installation.

In addition, reactive cooling approaches tend to be very conservative, setting relatively low temperature thresholds for turning on fans or other cooling resources. This is because there tends to be a lag between when a given cooling resource is turned on and when the cooling resource begins to take effect. For example, it may take several minutes for an air handler in a server installation to reduce temperatures by a significant amount (e.g., five degrees Celsius) at a given server container.

Because of the inefficiencies discussed above, proactive cooling approaches can significantly reduce energy expenditures relative to reactive approaches. However, anticipating thermal conditions on a computing device or in a server installation can be difficult. This is partly because workload demand can be hard to predict, e.g., a server installation operator or fan controller does not always know when a given service is going to experience high demand. Moreover, different workloads can generate different amounts of heat depending on resource utilization tendencies of the workloads. Specifically, some workloads (e.g., specific combinations of programs) can use resources on a given computing device in specific ways that tend to cause the computing device to use significant amounts of power (e.g., 90 watts out of a maximum of 100 watts) and accordingly generate substantial amounts of heat. Other workloads running on the same computing device might cause the server to use less power (e.g., 40 watts) and accordingly generate substantially less heat.

In view of the above, one way to mitigate cooling inefficiencies at the computing device level or at an aggregate (e.g., server installation) level is to manage cooling resources in a manner that considers interactions between executable programs on a particular processor. For example, some implementations may estimate the thermal impact of current or potential program configurations based on various factors, such as resource utilization by one or more executable programs running on a given computing device. For the purposes of this document, the term “program configuration” refers to a group of one or more executable programs that execute concurrently on a computing device. The term “executable program” refers to an instance of executable code, e.g., an application binary, an operating system or hypervisor binary, etc.

Some implementations may consider interactions between executable programs running on different cores of a single processor, such as how the executable programs use specific resources. For example, some implementations consider how different program configurations tend to use not only processor cores and cache, but also memory, storage, and/or network resources. Specific program configurations that tend to be thermally intense can be identified and proactive thermal management steps can be taken when these thermally-intense program configurations are scheduled on a given computing device. Some implementations estimate thermal impacts of various potential program configurations and select an individual program configuration for execution based on the estimated thermal impact of the selected program configuration.

### Example Computing Device

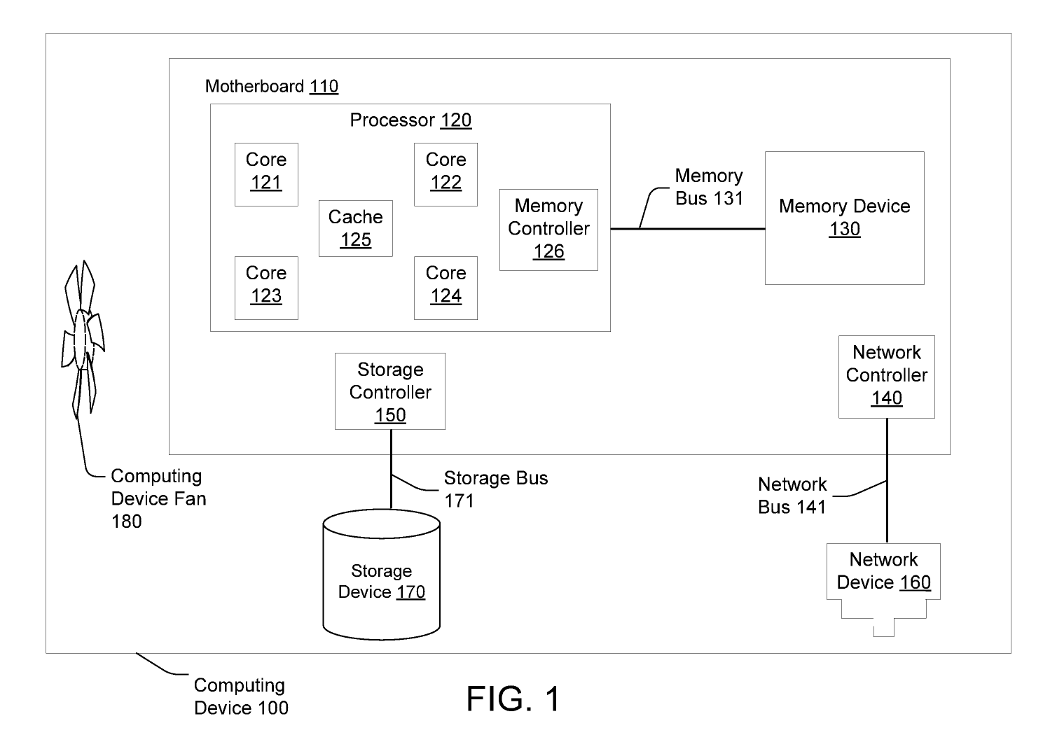

FIG. 1 illustrates an example computing device 100 with a motherboard 110 having a processor 120, memory device 130, network controller 140, and storage controller 150. The computing device also includes a network device 160, a storage device 170, and a computing device fan 180. Processor 120 includes cores 121, 122, 123, and 124, cache 125, and memory controller 126. The computing device fan can cool the computing device to address heat generated by using the cores, cache, memory, and the storage device. Note that FIG. 1 is an example and that the disclosed implementations can be employed for thermal management of many different types of computing devices, e.g., rack servers, blade servers, tower servers, desktop computers, laptops, mobile devices, etc.

Generally, each of the cores 121, 122, 123, and/or 124 can run a single executable program (e.g., a binary) at any given time. Different executable programs can be swapped onto individual cores at various times, including operating system programs as well as application programs. When a given core wants to access code or data stored at a particular memory address, the core can first attempt to retrieve that code or data from the cache 125. If the code or data is not present in the cache, the core can activate the memory controller 126 and retrieve the code or data from the memory device 130 into the cache. The code or data can be retrieved by the core over memory bus 131. Note that code and/or data can also be written to the cache as well as retrieved.

In some cases, code or data may not be present in the memory device 130 either, in which case the processor 120 can activate the storage controller 150 to retrieve the code or data from the storage device 170. In this case, the code or data can be retrieved from the storage device over storage bus 171. In some cases, the code and/or data is retrieved into memory device 130 and/or cache 125. Likewise, the code and/or data can be written to the storage device as well as retrieved from the storage device.

In further cases, code and/or data may be sent and/or retrieved over a network via network device 160. In this case, the core can activate the network controller 140 to send or retrieve the code and/or data using the network bus 141.

Generally, the cache 125, memory device 130, network device 160, and storage device 170 are examples of hardware resources on the computing device 100. As these hardware resources are activated by individual cores, heat is generated by the circuitry within these hardware resources and associated buses. For example, each of these hardware resources may have a certain number of transistors or other circuit components that consume power when the hardware resource is activated.

As mentioned, FIG. 1 shows merely one example of a computing device. For example, various components of a computing device may share a particular bus, e.g., the network device 160 and storage device 170 may share a bus (e.g., a Peripheral Component Interconnect bus). In other implementations, memory controller 126 can be located on a motherboard 110 instead of directly on the processor 120. As further examples, a backplane architecture can be employed and provide various bus connections for different types of hardware resources to communicate with the processor 120, memory 130, etc.

### Examples of Thermally Intense Workloads

Different executable programs tend to use hardware resources differently. For example, some executable programs might be relatively processor intensive, but might not use a great deal of memory, storage, or network resources. On the other hand, some executable programs might be relatively storage intensive, but not use a great deal of processor resources. Moreover, some executable programs may tend to have certain interactions with other executable programs that alter how these binaries use the hardware resources. For the purposes of this document, the term “hardware resources” encompasses various types of physical devices that can be controlled by a computer processor, including memory devices, storage devices, network devices, graphics cards, etc., as well as buses or other circuits used to communicate with these hardware resources.

To illustrate how different executable programs can cause different thermal impacts on a given computing device, consider the following example program configurations. In a first program configuration, a first executable program can share a processor on a computing device with a second executable program and generate a great deal of heat. In a second program configuration, the first executable program can share the processor with a third executable program and generate much less heat.

To understand how this can occur, assume that the first executable program is a processor intensive executable program executing on core 121 and uses the cache 125 quite heavily, thus activating the cache circuitry in an intense manner. For the purposes of this example, assume the first executable program consumes an average of 30 watts of energy. Now, assume the second executable program is executing on core 122 and is not as cache intensive, but uses the storage device 170 very heavily and accordingly activates the circuitry in storage device 170, storage controller 150, and storage bus 171 quite heavily, perhaps consuming 20 watts on average. The combination of the heat output by the cache circuitry and storage bus/device circuitry in this first program configuration is 50 watts.

Now, assume that the second executable program is replaced on core 122 with the third executable program, which is another processor intensive executable program that tends to use the cache 125 quite heavily. Under these circumstances, when the third executable program executes on core 122, code and/or data for the first executable program may be evicted from the cache 125 resulting in a lower cache hit rate for the first executable program. Likewise, when the first executable program executes on core 121, code and/or data for the third executable program may be evicted from the cache 125, resulting in a lower cache hit rate for the third executable program. As a consequence, both the first executable program and the third executable program may spend time waiting for data to be retrieved from memory. This may cause the combined power usage by the two executable programs to actually be less than the power used by the first executable program alone, e.g., 25 watts for the sake of example.

The broader point here is that conflicts for a single hardware resource often tend to reduce the utilization of that hardware resource, because one executable program enters a wait state while waiting for the other executable program to stop using the resource. On the other hand, the utilization of hardware resources tends to be high when workloads run executable programs that tend to be somewhat mutually exclusive in terms of the resources that they use heavily. As a consequence, workloads that run executable programs with mutually exclusive resource demands tend to generate more heat than workloads that run executable programs with resource conflicts.

The disclosed implementations generally leverage expected thermal impacts of workloads to preemptively address thermally intense workloads. Generally, two mitigation strategies are employed. First, the disclosed implementations detect when thermally intense workloads are scheduled or executing on a computing device and preemptively configure cooling resources before high temperatures are reached. Second, scheduling strategies can be employed so that thermally intense workloads are adjusted temporally (e.g., delayed) and/or spatially (e.g., moved to cooler locations) to smooth demands on cooling resources within the server installation.

### Example Computing Device Container

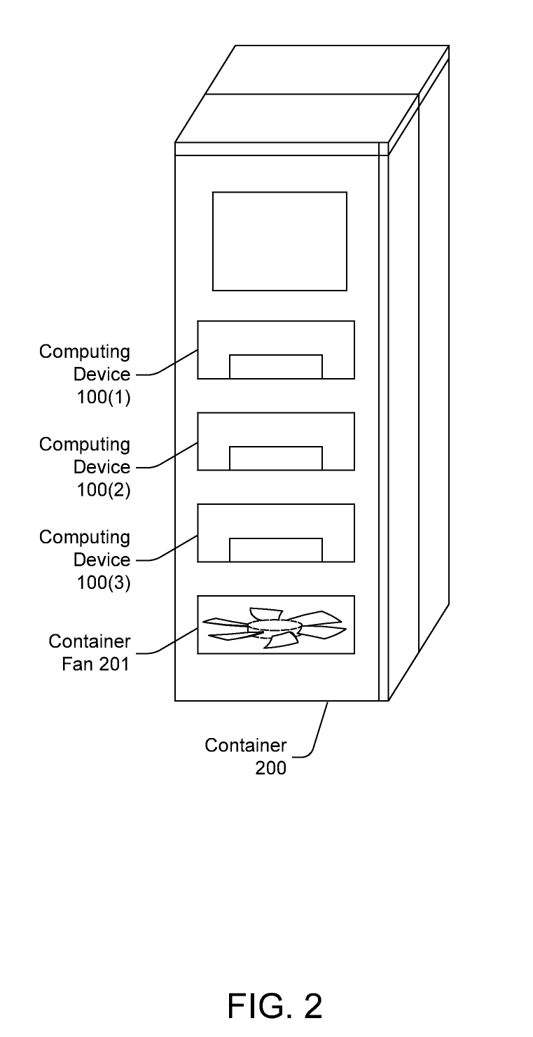

Computing device 100, as shown in FIG. 1, can be installed in a container 200 as shown in FIG. 2. Container 200 is shown with three computing devices, 100(1), 100(2), and 100(3), as well as a container fan 201 that can be used to cool the computing devices in container 200. In this discussion, the use of a designator with the suffix, such as “(1)”, is intended to refer to a specific instance of a device, device component, or module. In contrast, use of the designator without a suffix is intended to be generic. Note that container 200 can be of various types suitable for housing multiple computing devices, e.g., a server rack, rack enclosure, etc.

Generally, each individual computing device 100 can be configured as shown in FIG. 1. Thus, computing device 100(1), computing device 100(2), and computing device 100(3) can have their own separate motherboard 110, processor 120, memory device 130, network controller 140, storage controller 150, network device 160, storage device 170, and computing device fan 180. Note that heat generated by individual computing devices within the container 100 can have corresponding implications for other computing devices in the container. For example, heat rising from computing device 100(3) may cause computing devices 100(2) and 100(1) to experience thermal fluctuations irrespective of workloads running on computing devices 100(2) and 100(1).

### Example Server Installation

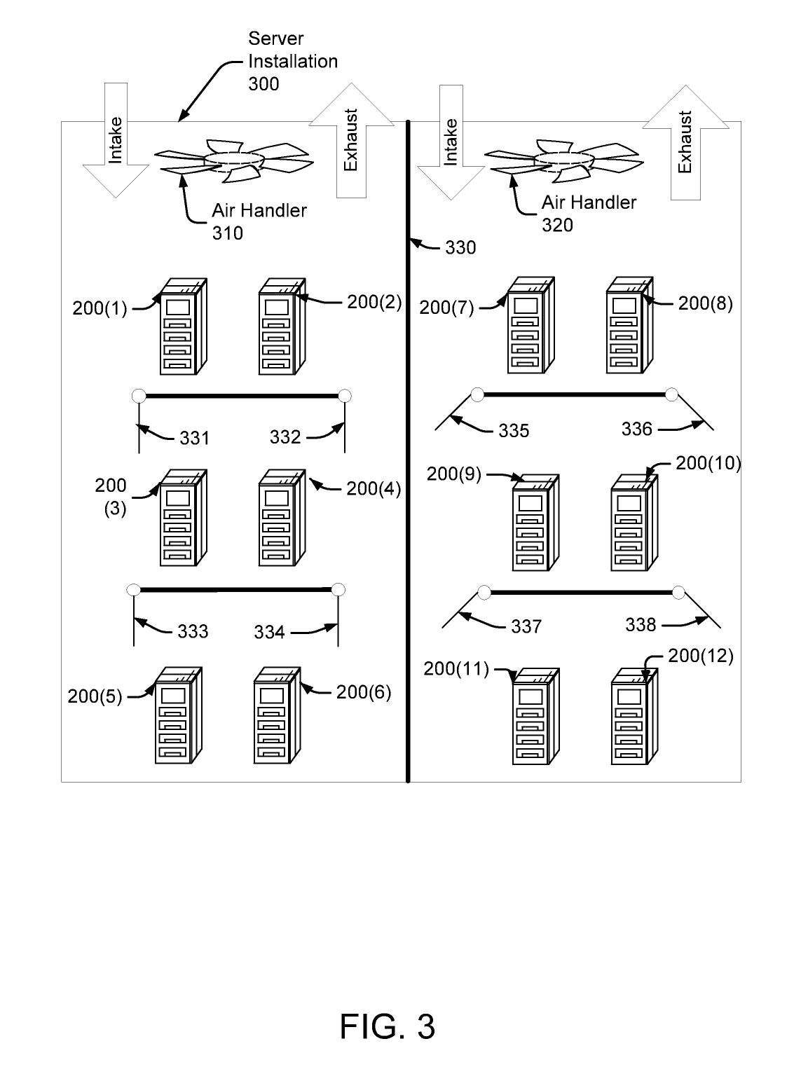

In some cases, multiple containers can be installed in a server installation 300, as shown in FIG. 3. Server installation 300 is shown with an air handler 310 and an air handler 320. Air handlers may be located on the roof of the server installation, on one or more sides of the server installation, etc. In addition, the air handlers may be internal and/or external to the server installation.

The server installation 300 may have multiple containers 200(1), 200(2), 200(3), 200(4), 200(5), 200(6), 200(7), 200(8), 200(9), 200(10), 200(11), and 200(12). Containers 200(1-6) are shown in FIG. 3 as being separated from containers 200(7-12) by a barrier 330, such as a wall. Generally speaking, barrier 330 can be any structure that sufficiently affects airflow such that most airflow produced by air handler 310 cools containers 200(1-6) and that most airflow produced by air handler 320 cools containers 200(7-12). Barrier 330 need not completely obstruct airflow between these groups of containers. Also, note that disclosed implementations encompass use of a wide variety of containers configured to contain discrete electrical components (e.g., with variable heat densities), including blade server systems, tower server systems, or other configurations.

Server installation 300 may also have airflow directors 331, 332, 333, and 334 on one side of barrier 330 and airflow directors 335, 336, 337, and 338 on the other side of barrier 330. The function of these airflow directors is to direct airflow within the server installation. As shown in FIG. 3, airflow directors 331, 332, 333, and 334 are shown in a wide-open configuration where airflow can freely pass past all of the containers 200(1-6). Air handlers 310 and/or 320 may provide a constant or varying pressure differential that is sufficient to cool all of containers 200(1-6) when these containers are running at full utilization. However, maintaining such a pressure differential may use substantial amounts of power. In contrast, airflow directors 335, 336, 337, and 338 are shown in a partially closed configuration that limits the amount of airflow to containers 200(7-12). This may allow air handler 320 to maintain a similar pressure differential to air handler 310 while using relatively less power. The reduced airflow to containers 200(7-12) may be insufficient to cool these server racks at full utilization, however.

In addition, note that the figures herein illustrate airflow directors in a generic configuration that can be adjusted depending upon the specific layout of the server installation. For example, some server installations may use airflow beneath the server racks for cooling purposes. In addition, air handlers can be provided in various configurations, with and/or without active cooling capacity (e.g., air conditioning). More generally, for the purposes of this document, the term “air handler” refers to any mechanism that can move air within a building, including fans without active cooling capacity, air conditioners, or other cooling mechanisms. In addition, note that other implementations can utilize other gases or liquids for cooling purposes, e.g., water. In such implementations, liquid handling mechanisms (e.g., pumps, valves) can be used in a manner similar to that discussed herein with respect to the air handlers, computing device fans, and/or container fans. More generally, the disclosed implementations encompass any mechanism that can be used to reject heat by pumping a fluid into a space. Thus, liquid or other cooling mechanisms can also be used to cool individual computing devices (e.g., in addition to or replacing computing device fan 180) or to cool computing device containers (e.g., in addition to or replacing container fan 201).

Also note that the term “director” is used herein in a generic sense to refer to any device that can alter the flow characteristics of a gas or liquid. For example, airflow can be deflected by opening/closing louvers, opening/closing flaps, damper arrangements, etc. Analogously, in cases where water is used to cool servers, water deflection technologies such as valves or other mechanisms can be used.

### Example Network Scenario

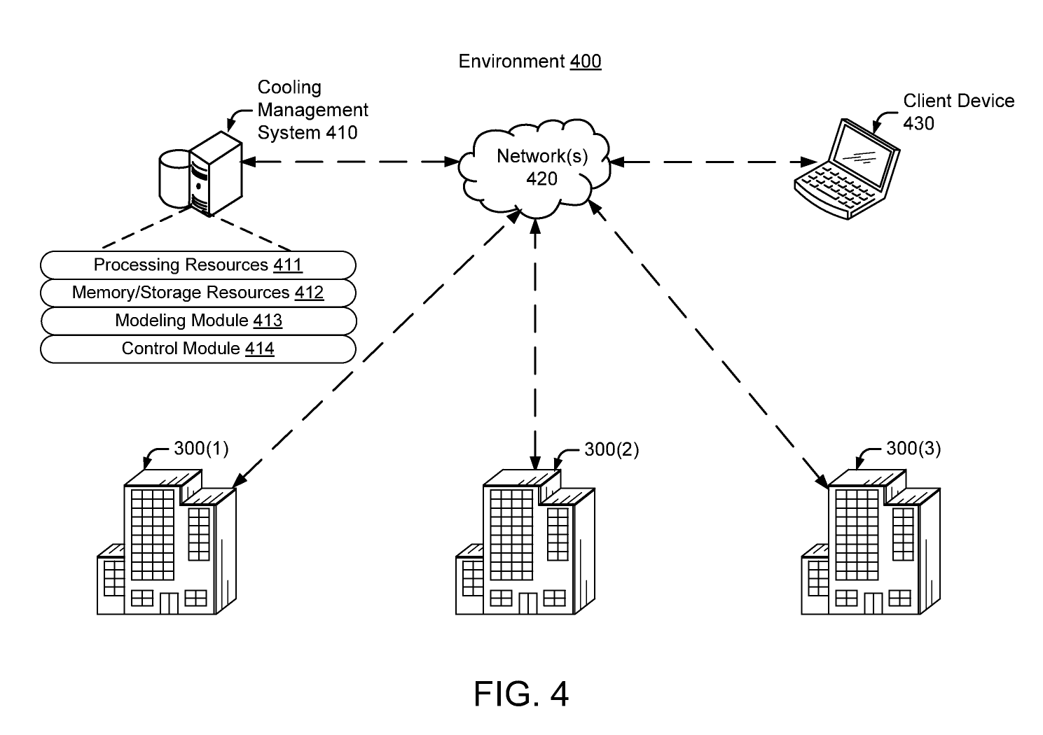

One specific environment in which the disclosed techniques can be performed is shown in FIG. 4, which shows an example environment 400 including a cooling management system 410 connected via a network 420 to a client device 430 and server installations 300(1), 300(2), and/or 300(3). Server installations 300(1), (2), and/or (3) may be configured as shown in FIG. 3, although each server installation need not be identical and indeed may be quite different depending upon the specific implementation.

Cooling management system 410 can include a modeling module 413 and a control module 414. Generally speaking, the modeling module can model the thermal impact of various workloads on a computing device. The control module 414 can provide cooling management functionality such as controlling cooling resources such as individual computing device fans 180, container fans 201, air handlers 310 and 320, and airflow directors 331-338 within each individual server installation. In further implementations, the control module may perform scheduling of individual executable programs within any of server installations 300(1)-(3). For the purposes of the following examples, assume that executable programs can be moved to different computing devices, e.g., within an individual container, to different containers within a given server installation, or from a computing device in one server installation to a computing device in another server installation. The client device 430 may request certain processing be performed by a cloud service, and the cloud service may perform the processing using jobs running on any computing device in any of the server installations 300(1)-(3). For the purposes of this document, the term “job” encompasses an execution of at least one executable program, e.g., an application program.

Note that cooling management system 410 is shown in FIG. 4 as located externally from server installations 300(1)-(3). In further implementations, the cooling management system may be collocated with any or all of the server installations. For example, in some cases, server installation 300(1) may have the cooling management system located therein and the cooling management system may perform thermal management locally within server installation 300(1) and also can send instructions to perform remote thermal management of server installations 300(2) and 300(3). In other cases, each server installation may have a corresponding local instance of the cooling management system that performs thermal management at that specific server installation. As also discussed more below, the cooling management system can be implemented as dedicated circuitry, e.g., a microcontroller that controls individual air handlers, container fans, computing device fans, etc.

Also, note that the cooling management system can include various processing resources 411 and memory/storage resources 412 used to execute the modeling module 413 and control module 414. These components of the cooling management system are discussed in more detail below in the section entitled “Device Implementations.”

### Thermal Modeling Method Based on Hardware State

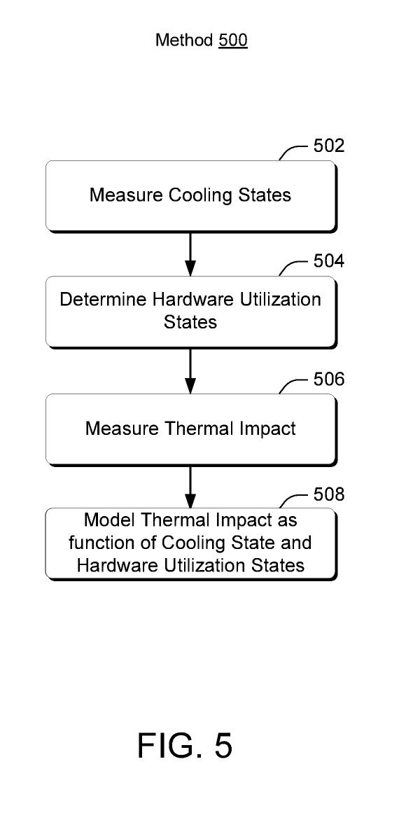

Some implementations may model the thermal impact of workloads as a function of cooling states and hardware utilization states. FIG. 5 shows a thermal impact modeling method 500 that can be performed by the modeling module 413 of cooling management system 410 or by other systems.

Block 502 can measure cooling states associated with a computing device at various times. For example, the cooling states can represent a current temperature at the computing device, a computing device fan speed, a container fan speed, an air handler speed, etc.

Block 504 can determine hardware utilization states associated with various hardware resources of the computing device. For example, the hardware utilization states can include a processor utilization state, a memory utilization state, a storage utilization state, and/or a network utilization state.

Block 506 can measure thermal impacts on the computing device in the cooling states and the hardware utilization states. For example, temperature changes on the computing devices can be measured over time.

Block 508 can model the thermal impacts on the computing device as a function of the cooling states and the hardware utilization states. In some cases, a mathematical function is derived that can be used to predict future thermal impacts of various workloads, as discussed more below.

As noted, the hardware utilization states determined at block 504 can describe usage of various types of hardware resources. For example, the processor utilization state can represent a current cache hit rate, an instruction execution rate, or other metrics describing activity of a processor or individual cores thereon. More generally, the term “processor utilization state” can refer to any value that describes the relative intensity with which processor circuitry (e.g., individual core circuitry, cache circuitry, etc.) is activated at any given time by a given workload.

As noted, another example of a hardware utilization state is a memory transfer state, which can represent a current memory bus transfer rate reflecting a rate at which instructions and/or data are being read from or transferred to the memory 130, e.g., from the processor 120, from the storage device 150, from the network device 160, etc. More generally, the term “memory utilization state” can refer to any value that describes the relative intensity with which memory chip circuitry and/or memory bus circuitry is activated at any given time by a given workload. Note that in this case, the amount of memory allocated at any given time may be of less interest than the actual memory transfer rate because transfers tend to cause additional heat generation whereas memory refresh cycles that merely preserve existing data/instructions without modification may generate relatively less heat. Moreover, high memory transfer rates tend to cause more heat generation than low memory transfer rates. Also, note that some implementations may monitor memory access patterns and sequential access patterns (as opposed to random) may be used as a proxy to identify high memory transfer rates. Sequential memory read patterns can be identified by reading memory addresses accessed by a given executable program.

As noted, another example of a hardware utilization state is a storage utilization state, which can represent a current storage bus transfer rate at which instructions and/or data are being read from the storage device 170 into the memory 130, transferred from the memory into the storage device, etc. More generally, the term “storage utilization state” can refer to any value that describes the relative intensity with which storage device circuitry and/or storage bus circuitry is activated at any given time by a given workload. As discussed above with respect to memory, the amount of storage space used by a given executable program may be of less interest than the actual storage transfer rate because storage transfers, like memory transfers, tend to cause additional heat generation relative to merely maintaining stored data on the storage device. Moreover, high storage transfer rates tend to cause more heat generation than low storage transfer rates.

As noted, another example of a hardware utilization state is a network utilization state, which can represent a current network bus transfer rate at which data are being received and/or sent over the network device 160. More generally, the term “network utilization state” can refer to any value that describes the relative intensity with which network device circuitry and/or network bus circuitry is activated at any given time by a given workload. As discussed above with respect to memory and storage, high network transfer rates tend to cause more heat generation than low network transfer rates.

In addition, note that the examples discussed herein refer to a single cache, memory device, storage device, and network device for the sake of illustration. The disclosed techniques can be employed for thermal management of computing devices with multiple caches (e.g., L1 and L2), multiple memory devices, multiple storage devices (including RAID configurations, magnetic drives, solid state drives, etc.), and multiple network devices.

### Example Temperature Data

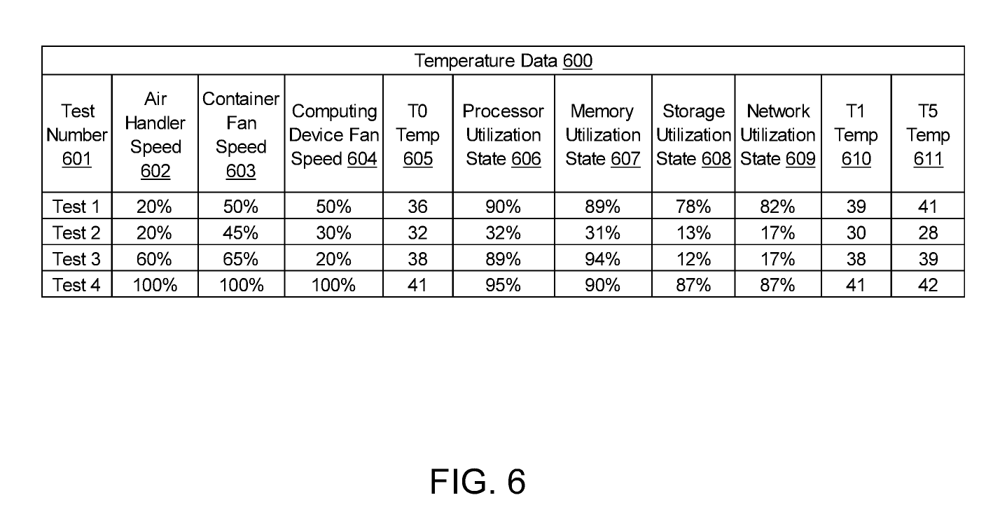

FIG. 6 illustrates example temperature data 600 that can be used to model thermal impacts as discussed above with respect to method 500. Temperature data 600 is shown with a test number column 601, which shows four example temperature test instances. However, note that FIG. 6 is an example and many more test instances may be conducted to obtain temperature data for modeling thermal impacts.

Temperature data 600 also includes an air handler speed column 602, a container fan speed column 603, a computing device fan speed column 604, a T0 temperature column 605, a processor utilization state column 606, a memory utilization state column 607, a storage utilization state column 608, a network utilization state column 609, a T1 temperature column 610, and a T5 temperature column 611. Each of these columns represent types of data that can be employed in method 500 for modeling of thermal impacts. In some cases, temperature data 600 is used to derive a temperature function as discussed further herein.

Air handler speeds, container fan speeds, computing device fan speeds, and/or temperature at time T0 are example types of data that can be used as the cooling states at block 502 of method 500. Processor utilization states, memory utilization states, storage utilization states, and/or network utilization states are example types of hardware utilization states that be used at block 504 of method 500. In FIG. 6, processor utilization state 606 is shown as a percentage, e.g., a cache hit percentage or a percentage instruction execution rate (e.g., relative to a maximum instruction execution rate). Memory utilization state 607 is shown as a memory transfer rate percentage representing a ratio between the current memory transfer rate and the peak transfer rate of the memory bus. Storage utilization state 608 is shown as a storage transfer rate percentage representing a ratio between the current storage transfer rate and the peak transfer rate of the storage bus. Network utilization state 609 is shown as a network transfer rate percentage representing a ratio between the current network transfer rate and the peak transfer rate of the network bus.

T1 temperature 610 and T5 temperature 611 can represent actual temperatures experienced at an individual computing device at 1 and 5 time units (e.g., milliseconds, seconds, minutes, etc.) after T0, respectively. Thus, T1 and T5 show how temperature changes relative to T0 given the cooling state and the hardware resource utilization states. Note that the values shown in FIG. 6 can be instantaneous values, e.g., taken at a single instance in time—T0 for columns 602-609, T1 for column 610, and T5 for column 611. In further implementations, smoothing and/or averaging techniques are employed so that individual values represent corresponding states over a period of time, e.g., a sliding window of average values for each column.

Generally, the disclosed implementations can learn a thermal impact function that outputs some measure of thermal impact (e.g., a predicted temperature in degrees, predicted heat generation in joules or BTU's, etc.) as a function of variables such as those shown in columns 602-609. In some cases, the thermal impact function is learned using a regression algorithm, e.g., a linear or non-linear regression that learns coefficients for values of the individual columns 602-609. Further implementations may use neural networks, Bayesian techniques, or other machine learning variants to learn the thermal impact function.

### Thermal Impact as Function of Hardware Utilization

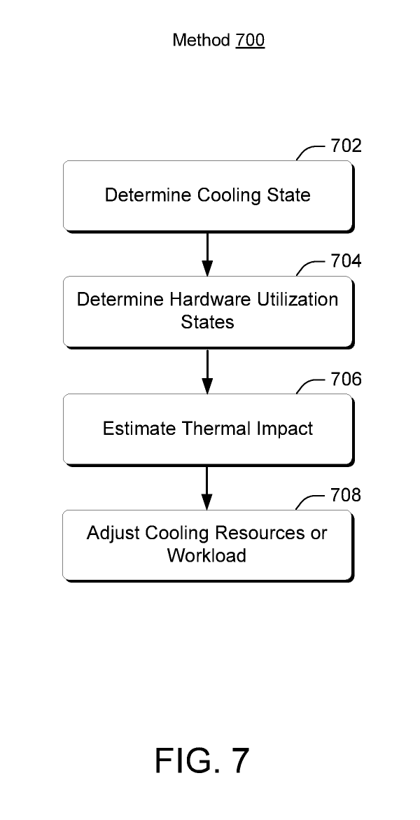

Some implementations may estimate a thermal impact on a given computing device based on hardware utilization states of the computing device. In some cases, the estimation can be performed using a thermal impact function which can be learned as discussed above. FIG. 7 shows a thermal impact estimation and control method 700 that can be performed by the control module 414 of the cooling management system 410.

Block 702 can determine a cooling state associated with a computing device. For example, the cooling state can reflect current or recent values for both temperatures and cooling resources, e.g., types of data discussed above with respect to columns 602, 603, 604, and 605 of temperature data 600.

Block 704 can determine one or more hardware utilization states of the individual server. As discussed above, example hardware utilization states are shown in columns 606, 607, 608, and 609 of temperature data 600.

Block 706 can estimate a thermal impact of operating the computing device based on the cooling state and the hardware utilization states. For example, some implementations may determine an expected future temperature based on factors such as the current cooling state, the processor utilization state, the memory utilization state, the storage utilization state, and/or the network utilization state. As noted, some implementations may estimate the expected future temperature using a model generated from training data such as temperature data 600 (FIG. 6). In some cases, the model is provided as a function that can be used to calculate expected future temperatures at various times in the future, e.g., 1 second, 5 seconds, etc.

Block 708 of method 700 can adjust a cooling resource or a workload based on the estimated thermal impact. For example, in some cases, an individual computing device fan can be turned on or off, or the speed of the fan can be adjusted, based on the estimated thermal impact. In other cases, estimated thermal impacts of multiple computing devices are aggregated and a shared cooling resource such as a container fan or air handler is turned on or off, or the speed adjusted, based on the aggregated thermal impact. In further cases, airflow deflectors can be adjusted to direct additional air toward individual computing devices or containers or to reduce the amount of air directed to the individual computing devices or containers.

### Examples of Cooling Adjustments Based on Hardware Utilization

In some implementations, adjustments to specific cooling resources are performed based on an expected temperature. For example, assume that temperatures for each computing device must be maintained below 45 degrees Celsius to prevent equipment damage. Further assume that the current temperature at an individual computing device is 35 degrees, so that the temperature can increase at most 10 degrees. Now, suppose that method 700 estimates that, at T5, the temperature will increase to 46 degrees given the current hardware utilization states and cooling state.

At this point, the cooling management system 410 can cause one or more cooling resources to increase output. For example, if the computing device is in a container with various other computing devices that are not at risk for thermal overload, the cooling management system may increase the speed of the local computing device fan rather than increase the speed of the container fan or an air handler that directs air to that container. On the other hand, if several of the computing devices in the container are at risk of thermal overload (e.g., estimated temp at T5 exceeds 45 degrees), the cooling management system might instead increase the speed of the container fan. If multiple containers serviced by a given air handler each have computing devices at risk of thermal overload, the cooling management system may increase the speed of that air handler instead. If a given container or containers located near one another are not at risk of thermal overload (e.g., containers 200(5) and (6) in FIG. 3) but another set are (e.g., containers 200(1-4)), then airflow directors can be adjusted to address this risk, e.g., by closing airflow directors 333 and 334 while leaving airflow directors 331 and 332 open.

Further implementations may coordinate multiple cooling resources according to the estimated thermal impacts. For example, a thermal impact for each computing device in the server installation can be determined and aggregated on a container-by-container basis as well as a room-by-room basis. An optimization algorithm can be applied to identify a specific set of computing device fan speeds, container fan speeds, air handler fan speeds, and/or air director configurations so that the cooling resources of the server installation are controlled in an integrated manner.

Also, note that hardware utilization can fluctuate in any given workload. Thus, temporarily high hardware utilization states do not necessarily imply that cooling output should be increased. In some implementations, a thermal impact function is used to calculate a buffering capacity, e.g., an estimated amount of time before additional cooling resources will be needed to avoid thermal overloads. Further implementations may employ a safety margin (e.g., 5 seconds) and begin increasing cooling resource output (e.g., fan speeds) whenever the estimated time to thermal overload falls below the safety margin. Further implementations may use different safety margins depending on how long the cooling resource takes to cool specific computing devices, e.g., air handlers may use a safety margin of several minutes, container fans a safety margin of 30 seconds, and individual computing device fans a safety margin of 5 seconds.

Also, note that some implementations may not calculate an explicit thermal impact. Rather, the cooling management system 410 can have rules that identify specific hardware utilization states and are mapped to corresponding cooling resource configurations. For example, a first rule might state that if a cache hit rate exceeds 70%, memory transfers are at least 60% of maximum throughput, storage transfers are at least 50% of maximum throughput, and network transfers are at least 40% of maximum throughput, then local computing device fan speeds are increased by 10%. In some cases, the rules can also have temperature parameters, e.g., if the aforementioned hardware utilization states are encountered when the computing device is at 35 degrees, the fan speeds are increased by 10%, but if these hardware utilization states are encountered when the computing device is at 40 degrees, the fan speeds are increased by 50%. In such an implementation, the cooling management system could be embodied as a local fan controller on an individual computing device (e.g., a microcontroller).

Also, as noted, some implementations may account for fluctuating hardware utilization over time. Thus, the rules introduced above could be modified so that the hardware utilization thresholds are averages, e.g., for the past minute. Thus, in this case, if the moving average for the past minute for a cache hit rate exceeds 70%, the moving average for memory transfer rates for the past minute exceeds 60%, the moving average for storage transfer rates for the past minute exceeds 50%, and the moving average for network transfer rates for the past minute exceeds 40%, then a given fan speed can be selected based on these hardware utilization averages and the current temperature.

Rules can also be defined on an aggregate basis for multiple computing devices. For example, an average cache hit rate, memory transfer rate, storage transfer rate, and network transfer rate can be determined for each computing device in a given container, server installation room, etc. If the averages for these values meet certain thresholds, similar techniques can be employed. In this case, the rule might specify that container fan speed is increased by 10% when the average temperatures for computing devices in the container is at 35 degrees, and the container fan speed is increased by 50% when the average temperatures for computing devices in the container is at 40 degrees. Analogously, an air handler fan speed could be increased by 10% when average temperatures for computing devices cooled by the air handler (e.g., in a specific room) are at 35 degrees and by 50% when the average temperatures are at 40 degrees. Note that the averages used for aggregate computing devices can also be moving averages over a span of time, e.g., the last minute, last 10 seconds, etc.

### Examples of Workload Adjustments Based on Hardware Utilization

Another way to address thermal impacts of workloads is by scheduling workloads on individual computing devices. For example, assume a given computing device has current utilization states of 90% for processor, memory, storage, and network, and is at a relatively high temperature. One or more executable programs can be moved from that computing device to another computing device with a lower temperature and/or with lower utilization states for one or more of the hardware resources.

In some cases, moving workloads can consider local cooling conditions at various candidate computing devices. For example, some implementations may evaluate local temperatures at different containers, rooms, or server installations to identify locations with enough thermal buffering capacity to handle high utilization workloads. As a specific example, assume an individual computing device in container 200(1) has very high utilization for processor, memory transfers, storage transfers, and network transfers, and is at a relatively high temperature. Further, assume that containers 200(5) and 200(6) are at relatively lower temperatures. One or more executable programs can be moved from container 200(1) to container 200(5) or (6) and this may be sufficient to prevent thermal overload and/or reduce energy expenditures for cooling purposes, even if high utilization states are also seen in container 200(5) or (6) for the executable programs that are moved. Also, note that further implementations may consider the elevation of a given computing device in a container. Generally, computing devices higher in the container are affected by heat generated by computing devices lower in the container, so some implementations may move or schedule executable programs with this as a consideration.

### Thermal Impact as Function of Program Configuration

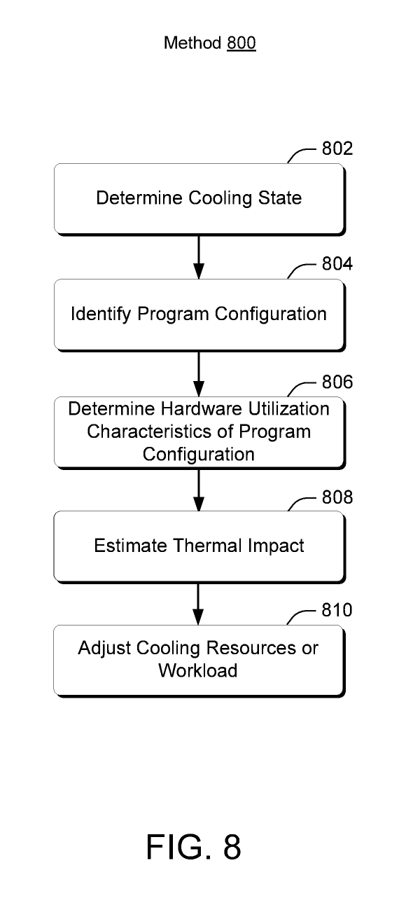

Method 700 can be used to estimate thermal impacts without regard to which executable programs are running on a given computing device. In other words, irrespective of which executable programs are running, the cooling state values and hardware utilization values mentioned above can provide sufficient information to derive expected thermal impacts on the computing device. However, further implementations may consider thermal impacts as a function of program configuration. The general idea is that specific executable programs can have particular resource utilization characteristics and thus can be expected to generate certain amounts of heat under certain circumstances. Furthermore, different executable programs running together on a single computing device can tend to interact in predictable way so that the thermal impact of running certain programs together can be predicted given this knowledge. FIG. 8 shows a method 800 that can be performed by cooling management system 410 or by other systems to compute heat generation as a function of program scheduling on a given server.

Block 802 of method 800 can determine a cooling state of an individual computing device, as discussed above with respect to block 502 of method 500.

Block 804 of method 800 can identify a program configuration on an individual computing device. As used herein, the term “program configuration” refers to a specific combination of executable programs for running concurrently on a particular computing device. Thermal impacts of a given program configuration can be estimated for current (e.g., actually running) program configurations as well as for prospective program configurations (e.g., for scheduling purposes).

Block 806 of method 800 can determine hardware utilization characteristics of the program configuration. For example, the hardware utilization characteristics can reflect processor usage characteristics, memory transfer rate characteristics, storage transfer rate characteristics, and/or network transfer rate characteristics for individual executable programs, as discussed elsewhere herein. In some implementations, these characteristics are determined for individual executable programs in isolation. In other implementations, interactions between various executable programs are considered to determine how different combinations of executable programs exhibit different resource utilization tendencies when executed on the same processor.

Block 808 of method 800 can estimate a thermal impact of operating the computing device in the program configuration given the cooling state. For example, as discussed more below, a given program configuration can be mapped to expected hardware utilization states which can, in turn, be used to determine the estimated thermal impact. In other implementations, thermal impacts can be modeled and estimated directly as a function of program configuration without explicitly mapping the program configuration to expected hardware utilization states.

Block 810 of method 800 can adjust a cooling resource or a workload based on the estimated thermal impact. To adjust the workload, a different program configuration can be scheduled on the computing device. To adjust a cooling resource, an individual computing device fan can be turned on or off, or the speed of the fan adjusted, based on the estimated thermal impact. In other cases, estimated thermal impacts of multiple computing devices are aggregated and a shared cooling resource such as a rack fan or air handler is turned on or off, or the speed adjusted, based on the aggregated thermal impact. In further cases, airflow deflectors can be adjusted to direct additional air toward individual computing devices or containers or to reduce the amount of air directed to the individual computing devices or containers.

### Example Program Characterization Data

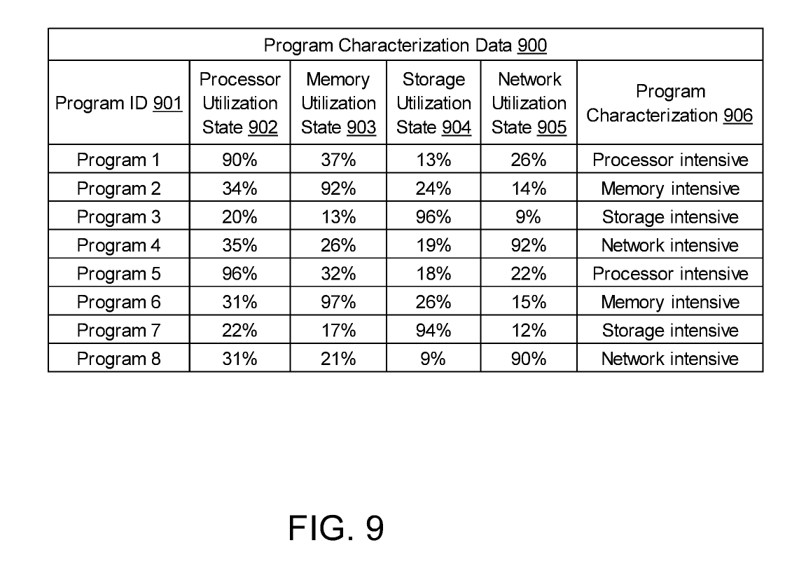

In some implementations, individual executable programs are characterized according to their hardware utilization characteristics. FIG. 9 illustrates example program characterization data 900 that characterizes individual executable programs. In some implementations, individual program characterizations are used to estimate thermal impacts of executing the individual programs, as discussed more below.

Program characterization data 900 includes a program ID column 901, a processor utilization state column 902, a memory utilization state column 903, a storage utilization state column 904, a network utilization state column 905, and a program characterization column 906. Program ID column 901 identifies a specific executable program. Generally, columns 902-905 can be similar to columns 606-609 of temperature data 600, but may represent long-term averages instead of instantaneous or smoothed measurements. For example, processor utilization state column 902 can represent a long-term average cache hit rate or instruction execution rate when executing the corresponding program. Similarly, memory utilization state column 903 can represent a long-term average memory transfer rate percentage when executing the corresponding program in column 901, storage utilization state 904 can represent a long-term average storage transfer rate percentage when executing the corresponding program in column 901, and network utilization state 905 can represent a long-term average network transfer rate percentage when executing the corresponding program in column 901. Program characterization column 906 shows a characterization for each individual executable program, e.g., identifies a specific resource that the corresponding executable program identified in column 901 tends to use heavily.

In FIG. 9, executable programs 1 and 5 are characterized as processor intensive programs because these executable programs tend to exhibit intense use of processor and/or cache circuitry. For example, executable programs 1 and 5 could be high performance computing applications such as fluid dynamics computations, radar navigation computations involving large matrix multiplications, etc. Executable programs 2 and 6 are characterized as memory intensive programs because these programs tend to exhibit intense use of memory and/or memory bus circuitry. For example, executable programs 2 and 6 could be graphics intensive programs that use large memory transfers between a graphics card (not shown) and memory. Executable programs 3 and 7 are characterized as storage intensive programs because these programs tend to exhibit intense use of storage devices and storage bus circuitry. For example, executable programs 3 and 7 could be high performance database applications that do a lot of storage logging to maintain transaction consistency. Executable programs 4 and 8 are characterized as network intensive programs because these programs tend to exhibit intense use of network devices and network bus circuitry. For example, executable programs 4 and 8 could be streaming media (video, audio, etc.) applications that send and/or receive large amounts of streaming media data over the network device.

Note that the characterizations shown in FIG. 9 are intentionally simplified for the purpose of illustrating certain inventive concepts. Certain executable programs may tend to use multiple resources intensely, e.g., may exhibit both high network transfer rates and storage transfer rates, etc. Moreover, executable programs can fluctuate in how they tend to use resources at various times depending on what data they are processing or other factors.

Because executable programs can exhibit fluctuations in how they use resources, the respective resource utilization characteristics discussed above may reflect resource utilization tendencies of a given application. For example, some implementations may use probabilistic approaches to characterize processor utilization or data transfer rates of memory, storage, and/or network devices. Other implementations may rank or weight resource usage by individual programs and characterize the programs according to which resources they tend to use most intensively relative to other programs. More generally, the term “utilization characteristic” as used herein refers to a broad range of quantitative and/or qualitative measures that describe resource usage by a given program or program configuration.

### Example Program Configuration Data

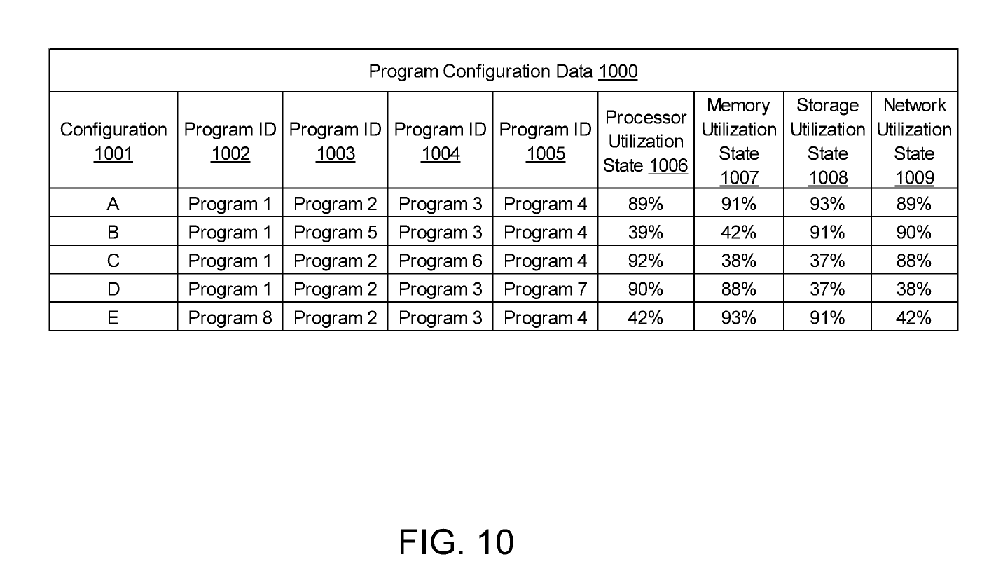

As noted above, some implementations may consider individual executable programs in isolation and estimate thermal characteristics of different application configurations based on the characteristics of the individual executable programs. However, as previously noted, sometimes executable programs exhibit certain resource usage patterns when run in isolation but change their resource usage patterns when executed on the same processor as another executable program. FIG. 10 illustrates example program configuration data 1000 that characterizes program configurations, e.g., different combinations of executable programs. In some implementations, individual program configurations are used to predict thermal impacts, as discussed more below.

Program configuration data 1000 includes a configuration column 1001, program ID columns 1002, 1003, 1004, and 1005, processor utilization state column 1006, memory utilization state column 1007, storage utilization state column 1008, and network utilization state column 1009. The configuration column uses a letter designation to refer to a specific combination of executable programs running on a given computing device, e.g., on different cores of a processor. Thus, configuration A can include executable program 1 executing on core 121, executable program 2 on core 122, executable program 3 on core 123, and executable program 4 on core 124. Likewise, configuration B has executable program 1 on core 121, executable program 5 on core 122, executable program 3 on core 123, and executable program 4 on core 124, and so on.

Columns 1006-1009 represent similar data to columns 902-905 of FIG. 9, e.g., long-term average utilization states for various hardware resources. However, note that program configuration data 1000 shows these states as measured when the corresponding programs are run in combination with one another on the same computing device, and thus can account for certain interactions that may occur between the individual programs.

As shown in FIG. 10, configuration A has a long-term average of 89% processor utilization (e.g., cache hit rate), 91% memory utilization (e.g., memory bus rate), a 93% storage utilization (e.g., storage bus rate), and an 89% network utilization (e.g., network bus rate). Thus, configuration A can be considered to exhibit high resource utilization for each of the hardware resources and can be expected to exhibit high heat generation characteristics. Referring back to FIG. 9, note that configuration A uses four executable programs that tend to be mutually exclusive in how they use hardware resources, e.g., executable program 1 tends to be processor intensive, executable program 2 tends to be memory bandwidth intensive, executable program 3 tends to be storage bandwidth intensive, and executable program 4 tends to be network bandwidth intensive.

Now, consider configuration B, which includes executable programs 1 (processor intensive), executable program 5 (processor intensive), executable program 3 (storage bandwidth intensive) and executable program 4 (network bandwidth intensive). This configuration exhibits relatively high storage utilization and network utilization, but relatively modest processor and memory utilization. Intuitively, the relatively modest memory utilization can be a function of the configuration not having any executable programs that are particularly bandwidth intensive on the memory bus. However, this configuration has two executable programs (1 and 5) that typically are processor intensive, yet processor utilization in this configuration is relatively modest, perhaps less so than either executable program when run in isolation. As previously mentioned, this can be caused by competition for a shared resource, in this case, the cache. Since both executable programs 1 and 5 need to periodically wait for the cache in order to run on their respective cores, the net effect of running these two executable programs together is decreased cache utilization and/or reduced instruction execution rate.

Similarly, configuration C shows high processor and network utilization due to processor intensive executable program 1 and network intensive executable program 4. Storage utilization in this configuration is relatively modest because none of the four executable programs is particularly storage bandwidth intensive. Furthermore, because both executable programs 2 and 6 are memory bandwidth intensive, these two executable programs tend to compete for control of the memory bus and thus the overall effect is lower memory bandwidth usage than when either executable program 2 or 6 operates in isolation.

Similar reasoning applies to configuration D, which shows high processor and memory utilization due to processor intensive executable program 1 and memory bandwidth intensive executable program 2. Network bandwidth utilization in this configuration is relatively modest because none of the four executable programs is particularly network intensive. Furthermore, because both executable programs 3 and 7 are storage bandwidth intensive, these two executable programs tend to compete for control of the storage bus and thus the overall effect is lower storage bandwidth usage than when either executable program 3 or 7 operates in isolation.

Similar reasoning applies to configuration E, which shows high memory and storage utilization due to memory bandwidth intensive executable program 2 and storage bandwidth intensive executable program 3. Processor utilization in this configuration is relatively modest because none of the four executable programs is particularly processor intensive. Furthermore, because both executable programs 4 and 8 are network bandwidth intensive, these two executable programs tend to compete for control of the network bus and thus the overall effect is lower network bandwidth usage than when either executable program 4 or 8 operates in isolation.

More generally, program configuration data 1000 can be used to characterize hardware utilization tendencies or patterns of different application configurations. Configuration A could be characterized as having high resource utilization tendencies for processor, memory, storage, and network resources. Configuration B could be characterized as having high resource utilization tendencies for storage and network, but moderate or low resource utilization tendencies for processor and memory. Configuration C could be characterized as having high resource utilization tendencies for processor and network, but moderate or low resource utilization tendencies for memory and storage. Configuration D could be characterized as having high resource utilization tendencies for processor and memory, but moderate or low resource utilization tendencies for storage and network. Configuration E could be characterized as having high resource utilization tendencies for memory and storage, but moderate or low resource utilization tendencies for processor and network.

In some cases, the long-term average hardware utilization values can be used to compute expected thermal impacts for each configuration. For example, the long-term values can be used in a function or other thermal model as discussed above with respect to method 500. More generally, program configurations that tend to exhibit mutually exclusive resource utilization can be characterized as thermally intense configurations, and program configurations that tend to exhibit mutual competition for resources can be characterized as less thermally intense configurations. Generally, more aggressive cooling strategies can be used for more thermally-intense configurations.

Also, note that program configuration data 1000 shown in FIG. 10 is an example to introduce the concepts discussed above. In practice, program configurations can exhibit many different resource utilization patterns. For example, refer back to configuration C, which includes two executable programs that are memory bandwidth intensive—programs 2 and 6. As described above, these executable programs can tend to compete for control of the memory bus resulting in lower memory bandwidth usage than when either executable program 2 or 6 operates in isolation. This may change, however, if program configuration C is run on a different computing device.

For example, assume configuration C is moved to another computing device with a much faster memory bus. In this case, executable programs 2 and 6 might exhibit much lower memory bus utilization on this computing device, e.g., perhaps 35% each. Thus, the likelihood of resource conflicts for these two programs is diminished by the faster bus, and configuration C might average 65% memory bus utilization on the computing device with the faster memory bus.

However, if a third executable program with intensive memory bus utilization is scheduled with both programs 2 and 6, even with the faster memory bus, the net memory bus utilization may decrease due to resource conflicts among the three memory bus intensive applications. For example, the memory bus utilization might be 50% with all three programs running concurrently. More generally, the overall utilization of a given resource does not necessarily decrease when two programs that use that resource extensively are scheduled to run concurrently. Rather, there may be a “tipping point” where scheduling another program that uses that specific resource intensively causes utilization of the resource to decrease instead of increase. As a consequence, running multiple concurrent memory bus intensive programs on a computing device with a fast memory bus might tend to increase heat generation up until this tipping point is reached, and thereafter the heat generation might tend to decrease as further memory intensive programs are added. This can also be the case for the other resources discussed herein, and thus some implementations can estimate thermal impacts of various program configurations accordingly.

### Examples of Cooling Adjustments Based on Program Configuration

Generally, any of the cooling resource adjustments described elsewhere herein can be employed based on thermal impacts estimated as a function of program configuration. For example, specific program configurations can have associated fan speeds or fan thresholds. As one specific example, program configuration A could have an associated rule for running an individual computing device fan. When a given computing device is running in configuration A, then the computing device fan may turn on at 25% of full speed at 30 degrees, increase to 50% at 35 degrees, and increase to 100% at 38 degrees. In contrast, another rule for configuration B might specify that the device fan turns on at 25% at 35 degrees, 50% at 38 degrees, and 100% at 40 degrees. The general idea here is that configuration B is expected to generate less heat overall than configuration A, so the corresponding thresholds and fan rates are set so that the fans are used less aggressively for configuration B.

As discussed previously, cooling resources can also be coordinated for groups of computing devices, e.g., in an individual container, room, or server installation. For example, one approach might control a container fan based on the configuration of multiple computing devices in the container. If each of the computing devices in the container is running configuration A, then an aggressive container fan approach can be used, e.g., turning on the container fan at 25% of full speed when the average temperature in the container is at 30 degrees, 50% at 35 degrees, and 100% at 38 degrees. If each of the computing devices is running configuration B, a less aggressive approach can be used, e.g., turning on the container fan 25% at 35 degrees, 50% at 38 degrees, and 100% at 40 degrees. In cases where a mix of configurations is running in a given container, intermediate rules can be defined, e.g., a container with 2 computing devices in configuration A and two computing devices in configuration B might turn on the container fan at 25% of full speed at 33 degrees, 50% at 37 degrees, and 100% at 39 degrees. Some implementations may interpolate between fan speeds specified at specific temperatures to determine fan speeds for unspecified temperatures.

This logic can be similarly extended to rooms of a server installation, locations in the server installation, or the entire server installation. Locations in the server installation running relatively thermally intense application configurations (e.g., a room running primarily configuration A) might receive extra cooling resources relative to another location in a less intense configuration (e.g., another room running primarily configuration B). This may be the case even when the temperatures in the two locations are identical, because configuration A is generally expected to generate more heat.

Note also that the thresholds for turning on various cooling resources may not be as conservative as would be the case for a reactive approach. For example, in a reactive approach, the air handler fans might be turned on at 100% once the temperature at any individual computing device reaches 35 degrees. This 35 degree threshold can be based on a worst-case scenario that contemplates very high resource utilization on that computing device as well as high heat generation by other nearby computing devices (e.g., in the same or nearby containers). The disclosed implementations may allow the air handler to be turned on at slower speeds and/or at higher temperatures. This is because the disclosed implementations may be able to estimate future heat generation by various program configurations and thus do not necessarily assume a worst-case scenario for each computing device.

### Examples of Workload Adjustments Based on Program Configuration

Some implementations may consider thermal characteristics of applications when scheduling executable programs on different computing devices. For example, assume that program 3 (storage intensive) needs to be scheduled on a computing device, and that two different computing devices have a free scheduling slot (e.g., a free core). Further, assume both computing devices are already at relatively high temperatures. If the first computing device is already running a processor intensive, memory intensive program, and a network intensive program but not a storage intensive program, then program 3 is likely to run largely uninhibited on the first computing device and generate a great deal of heat by having unrestricted access to the storage device. On the other hand, if the second computing device is already running a storage intensive program, then program 1 is likely to compete for the storage bus on that computing device and cause the second computing device to generate less heat.

One way to address this situation is to schedule program 3 on the second computing device so that less heat is generated. However, note that doing so generally means that the storage device on the second computing device will see lower utilization. Typically, the server installation operator does not want to run their computing devices at low utilization. Rather, they want to use their cooling resources efficiently while running their computing devices at high utilization. Thus, some implementations might schedule program 3 on the first computing device. Because it may take some time for program 3 to start running and building heat, further implementations may precool the first computing device before program 3 is even scheduled to run.

Viewed from another perspective, some implementations may aim to schedule mutually compatible programs on a given computing device. For the purpose of this document, the term “mutually compatible” implies a group of programs that tend to use disjoint sets of resources. For example, configuration A represents a mutually compatible configuration because each program in configuration A tends to use different resources heavily and, accordingly, computing devices in configuration A tend to have high resource utilization for each of the hardware resources thereon.

Now, consider a computing device running applications 2, 3, and 4. Some implementations may preferentially schedule applications 1 or 5 on this computing device instead of applications 6, 7, and 8 because applications 1 and 5 are less likely to compete for resources with existing applications 2, 3, and 4. However, because the likely result of this scheduling approach is increased heat utilization, some implementations may allocate additional cooling resources to this computing device even before applications 1 and 5 are scheduled thereon. For example, some implementations may begin precooling the computing device in anticipation of program 1 or 5 beginning to execute with applications 2, 3, and 4 on the computing device.

As another example, some implementations might preferentially schedule programs 2 or 6 on a computing device running programs 1, 3, and 4. Likewise, some implementations might preferentially schedule programs 3 or 7 on a computing device running programs 1, 2, and 4. Similarly, some implementations might preferentially schedule programs 4 or 8 on a computing device running programs 1, 2 and 3. In each case, the cooling management system 410 might precool the computing device in anticipation of running a thermally-intense workload.

Generally, precooling can be performed using any of the cooling resources discussed herein. For example, an individual computing device can be precooled by turning on or increasing speed of the local computing device fan, a container fan of a container that houses the computing device, and/or an air handler that cools multiple containers including the container housing the individual computing device. As noted previously, fluid pumps or valves as well as various types of flow directors, louvers, and vents can also be used to precool computing devices.

### Joint Optimization of Cooling Resources and Program Configuration

The aforementioned discussion largely treated cooling resources and program scheduling independently. However, further implementations may consider various combinations of thermal management strategies that employ both cooling resource adjustments as well as scheduling. For example, some implementations may consider various potential scheduling and cooling configurations and evaluate expected thermal impacts.

As a specific example, assume the server installation would like to run an equal number of instances of configuration A and configuration B on different computing devices and limit computing device temperatures to no more than 40 degrees. The cooling management system 410 can evaluate various alternatives placement schemes. For example, some schemes might run configurations A and B on each container, segregate configurations A and B across different containers within the same room, or even segregate the server installations so that all containers in a given room run only one configuration. The cooling management system can also evaluate energy expenditures associated with various combinations of computing device fan speeds, container fan speeds, air handler speeds, and deflector configurations. In some cases, an optimization algorithm can be employed to arrive at an optimal or near optimal combination of program scheduling and cooling resource configuration.

More generally, by aggregating expected thermal impacts of individual program configurations on individual computing devices, an overall perspective of the server installation can be obtained. Since each individual cooling resource can be separately controllable and scheduling mechanisms allow different configurations to be run on different computing devices, a wide range of possible job placements and cooling resource configurations can be evaluated.

### Device Implementations

Referring back to FIG. 4, environment 400 as shown includes several components. In this case, for purposes of explanation, the components are characterized as a cooling management system 410, client device 430, and server installations 300(1), 300(2), and 300(3). In this example, the cooling management system can be manifest as a server computing device, desktop, tablet, laptop device, etc. Generally, so long as a device has some computational hardware, the device can act as the cooling management system in accordance with the disclosed implementations. Of course not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability (e.g., processing resources 411) and/or hardware storage/memory capability (e.g., memory/storage resources 412). Processing capability can be provided by one or more processors (e.g., hardware processing units/cores) that can execute computer-readable instructions to provide functionality. Computer-readable instructions and/or data can be stored on storage or memory.

The storage/memory can be internal or external to the device. The storage can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose processor and storage/memory. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor” as used herein can also refer to central processing units (CPUs), graphical processing units (CPUs), controllers, microcontrollers, processor cores, or other types of processing devices suitable for implementation both in conventional computing architectures as well as SOC designs.

In some configurations, the modeling module 413 and/or the control module 414 can be installed as hardware, firmware, or software during manufacture of the device or by an intermediary that prepares the device for sale to the end user. In other instances, the end user may install these modules later, such as by downloading executable code and installing the executable code on the corresponding device.

Also note that devices generally can have input and/or output functionality. For example, computing devices can have various input mechanisms such as keyboards, mice, touchpads, voice recognition, etc. Devices can also have various output mechanisms such as printers, monitors, etc.

Also note that the devices described herein can function in a stand-alone or cooperative manner to implement the described techniques. For example, the methods discussed herein can be performed on a single computing device and/or distributed across multiple computing devices that communicate over network(s) 420. Without limitation, network(s) 420 can include one or more local area networks (LANs), wide area networks (WANs), the Internet, and the like.

In some cases, the cooling management system 410 operates by sending instructions to individual cooling resources and/or computing devices. For example, the cooling management system can be a remotely-located computer that sends cooling instructions to each server installation to adjust air handlers, airflow directors, container fans, computing device fans, pumps, valves, vents, louvers, etc. Such implementations can also send scheduling instructions to individual computing devices to adjust workloads, as discussed elsewhere herein.

In other cases, the cooling management system 410 is provided locally in each server installation, e.g., one cooling management system in server installation 300(1), another in server installation 300(2), and another in server installation 300(3). In some cases, the cooling management system executes on an individual computing device in one of the containers as shown in FIG. 3, but in other cases is located elsewhere in the server installation, e.g., in a control room.

As also noted above, the cooling management system 410 can be provided as a microcontroller or other dedicated control circuit (e.g., FPGA, ASIC). In some cases, the cooling management system can be located on a motherboard or backplane of an individual computing device and control only the local computing device fan thereon. In other cases, the cooling management system can be provided as a dedicated control circuit in a container of multiple computing devices and receive cooling state data from those computing devices. In this case, the cooling management system can control the local container fan and, in some cases, the computing device fans for the computing devices in the container. Analogously, the cooling management system can be provided as a dedicated control circuit for an individual room of a server installation, for the entire server installation, or other configurations depending on the specific layout of the server installation.

### Further Examples

The various examples discussed herein can include a first system example having a hardware processing unit and a hardware storage device storing instructions. When executed by the hardware processing unit, the instructions of the first system example can cause the hardware processing unit to measure cooling states associated with a computing device at various times. The computing device can have hardware resources including a processor, a memory device, and a storage device. The instructions can also cause the hardware processing unit to determine hardware utilization states of the computing devices at the various times. The hardware utilization states can include a processor utilization state associated with the processor, a memory utilization state associated with the memory device, and a storage utilization state associated with the storage device. The instructions can also cause the hardware processing unit to measure thermal impacts on the computing device of operating in the cooling states and hardware utilization states. The instructions can also cause the hardware processing unit to model the thermal impacts as a function of the cooling states and the hardware utilization states. In a second system example, the hardware utilization states of the first system example include a network utilization state associated with a network device of the computing device. In a third system example, the instructions of the first or second system example cause the hardware processing unit to model the thermal impacts by employing a regression algorithm to determine a first coefficient for the processor utilization state, a second coefficient for the memory utilization state, a third coefficient for the storage utilization state, and a fourth coefficient for the network utilization state.

The various examples discussed herein can also include a first additional system example having a hardware processing unit and a hardware storage device storing instructions. The instructions of the first additional system example can cause the hardware processing unit to determine a cooling state associated with a computing device. The computing device can have hardware resources including a processor and another hardware resource. The instructions can also cause the hardware processing unit to determine hardware utilization states of the computing device. The hardware utilization states can include a processor utilization state and another hardware utilization state associated with the another hardware resource. The instructions can also cause the hardware processing unit to estimate a thermal impact on the computing device of operating in the cooling state and the hardware utilization states. In a second additional system example, the instructions of the first additional system example can cause the hardware processing unit to adjust a cooling resource based on the estimated thermal impact. In a third additional system example, the cooling resource of the second additional system example is a local computing device fan. In a fourth additional system example, the first through third additional system examples can be embodied as a dedicated cooling control circuit on the individual computing device or as a separate computing device. In a fifth additional system example, the another hardware resource of the first through fourth additional system examples includes a memory device and the another hardware utilization state reflects transfer rates over a memory bus used to communicate between the processor and the memory device. In a sixth additional system example, the another hardware resource of the first through fifth additional system examples includes a storage device and the another hardware utilization state reflects transfer rates over a storage bus used to communicate between the processor and the storage device. In a seventh additional system example, the another hardware resource of the first through sixth additional system examples includes a network device and the another hardware utilization state reflects transfer rates over a network bus used to communicate between the processor and the network device.

The various examples discussed herein can also include a first method example that includes determining a cooling state associated with a computing device. The computing device can have hardware resources including a processor and at least one of a memory device, a storage device, or a network device. The first method example can also include identifying a program configuration for the computing device. The program configuration can include a first executable program running on the computing device concurrently with a second executable program. The first method example can also include determining hardware utilization characteristics of the program configuration. The hardware utilization characteristics can include a processor utilization characteristic and a data transfer characteristic of the program configuration. The data transfer characteristic can reflect data transfers by the memory device, the storage device, or the network device. The first method example can also include estimating a thermal impact of operating the program configuration on the computing device when the computing device is in the cooling state. In a second method example, the processor of the first method example includes a first core and a second core and the program configuration includes a first executable program running on the first core and a second executable program running on the second core. In a third method example, the determining the hardware utilization characteristics of the program configuration of the first or second method examples includes executing the first executable program and the second executable program together on the processor and determining the processor utilization characteristic based on an average processor utilization state of the processor when the first executable program and the second executable program are both running on the processor. In a fourth method example, the determining the hardware utilization characteristics of the program configuration of the first through third method example includes executing the first executable program and the second executable program together on the processor and determining the data transfer characteristic based on an average memory utilization state when the first executable program and the second executable program are both running on the processor. In a fifth method example, the determining the hardware utilization characteristics of the program configuration of the first through fourth method examples includes executing the first executable program and the second executable program together on the processor and determining the data transfer characteristic based on an average storage utilization state when the first executable program and the second executable program are both running on the processor. In a sixth method example, the determining the hardware utilization characteristics of the program configuration of the first through fifth method examples includes executing the first executable program and the second executable program together on the processor and determining the data transfer characteristic based on an average network utilization state when the first executable program and the second executable program are both running on the processor. In a seventh method example, the first through sixth method examples include, prior to executing the program configuration on the computing device, adjusting a cooling resource based on the estimated thermal impact. In an eighth method example, the cooling resource of the first through seventh method examples includes an individual computing device fan, a container fan, or an air handler fan. In a ninth method example, the cooling resource of the first through eighth method examples includes a pump or a valve that directs fluid to cool the computing device. In a tenth method example, the first through ninth method examples include adjusting workload on the computing device by selecting another program configuration to run on the computing device. The another program configuration can be selected based on another estimated thermal impact of the another program configuration.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A system comprising:
a hardware processing unit; and
a hardware storage device storing instructions which, when executed by the hardware processing unit, cause the hardware processing unit to:
measure cooling states associated with a computing device at various times, the computing device having hardware resources including a processor, a memory device, and a storage device;
determine hardware utilization states of the computing devices at the various times, the hardware utilization states including a processor utilization state associated with the processor, a memory utilization state associated with the memory device, and a storage utilization state associated with the storage device;
measure thermal impacts on the computing device of operating in the cooling states and hardware utilization states; and
model the thermal impacts as a function of the cooling states and the hardware utilization states.

2. The system of claim 1, wherein the hardware utilization states include a network utilization state associated with a network device of the computing device.

3. The system of claim 2, wherein the instructions, when executed, cause the hardware processing unit to:
model the thermal impacts by employing a regression algorithm to determine a first coefficient for the processor utilization state, a second coefficient for the memory utilization state, a third coefficient for the storage utilization state, and a fourth coefficient for the network utilization state.

4. A system comprising:
a hardware processing unit; and
a hardware storage device storing instructions which, when executed by the hardware processing unit, cause the hardware processing unit to:
determine a cooling state associated with a computing device, the computing device having hardware resources including a processor and another hardware resource;
determine hardware utilization states of the computing device, the hardware utilization states including a processor utilization state and another hardware utilization state associated with the another hardware resource;
estimate a thermal impact on the computing device of operating in the cooling state and the hardware utilization states.

5. The system of claim 4, wherein the instructions, when executed, cause the hardware processing unit to:
adjust a cooling resource based on the estimated thermal impact.

6. The system of claim 5, wherein the cooling resource is a local computing device fan.

7. The system of claim 6, embodied as a dedicated cooling control circuit on the individual computing device or as a separate computing device.

8. The system of claim 4, wherein the another hardware resource is a memory device and the another hardware utilization state reflects transfer rates over a memory bus used to communicate between the processor and the memory device.

9. The system of claim 4, wherein the another hardware resource is a storage device and the another hardware utilization state reflects transfer rates over a storage bus used to communicate between the processor and the storage device.

10. The system of claim 4, wherein the another hardware resource is a network device and the another hardware utilization state reflects transfer rates over a network bus used to communicate between the processor and the network device.

11. A method comprising
determining a cooling state associated with a computing device, the computing device having hardware resources including a processor and at least one of a memory device, a storage device, or a network device;
identifying a program configuration for the computing device, the program configuration including a first executable program running on the computing device concurrently with a second executable program;
determining hardware utilization characteristics of the program configuration, the hardware utilization characteristics including a processor utilization characteristic and a data transfer characteristic of the program configuration, the data transfer characteristic reflecting data transfers by the memory device, the storage device, or the network device; and
estimating a thermal impact of operating the program configuration on the computing device when the computing device is in the cooling state.

12. The method of claim 11, wherein the processor includes a first core and a second core and the program configuration includes a first executable program running on the first core and a second executable program running on the second core.

13. The method of claim 12, wherein the determining the hardware utilization characteristics of the program configuration comprises:
executing the first executable program and the second executable program together on the processor; and
determining the processor utilization characteristic based on an average processor utilization state of the processor when the first executable program and the second executable program are both running on the processor.

14. The method of claim 12, wherein the determining the hardware utilization characteristics of the program configuration comprises:
executing the first executable program and the second executable program together on the processor; and
determining the data transfer characteristic based on an average memory utilization state when the first executable program and the second executable program are both running on the processor.

15. The method of claim 12, wherein the determining the hardware utilization characteristics of the program configuration comprises:
executing the first executable program and the second executable program together on the processor; and
determining the data transfer characteristic based on an average storage utilization state when the first executable program and the second executable program are both running on the processor.

16. The method of claim 12, wherein the determining the hardware utilization characteristics of the program configuration comprises:
executing the first executable program and the second executable program together on the processor; and
determining the data transfer characteristic based on an average network utilization state when the first executable program and the second executable program are both running on the processor.

17. The method of claim 11, further comprising:
prior to executing the program configuration on the computing device, adjusting a cooling resource based on the estimated thermal impact.

18. The method of claim 17, wherein the cooling resource is an individual computing device fan, a container fan, or an air handler fan.

19. The method of claim 17, wherein the cooling resource includes a pump or a valve that directs fluid to cool the computing device.

20. The method of claim 11, further comprising:
adjusting workload on the computing device by selecting another program configuration to run on the computing device, the another program configuration being selected based on another estimated thermal impact of the another program configuration.
